(19) United States
(12) Patent Application Publication
(10) Pub. No.: US 2009/0324393 A1
(43) Pub. Date: Dec. 31, 2009

(54) Ceramic matrix composite turbine engine component

(75) Inventors: Malberto F. Gonzalez, Orlando, FL (US); Jay A. Morrison, Oviedo, FL (US)

Correspondence Address: Siemens Corporation;Intellectual Property Department, 170 Wood Avenue South, Iselin, NJ, 08830, US

(73) Assignee: Siemens Power Generation, Inc.

(21) Appl. No.: 11/698,225

(22) Filed: Jan. 25, 2007

(51) Int. Cl. F02C 7/28; B23P 11/00

(52) U.S. Cl. 415/170.1; 29/889.2

(57) ABSTRACT

Aspects of the invention are directed to a gas turbine component such as a ring seal segment or combustor heat shield having a base and a plurality of walls defining a volume. The base and the walls are independently formed and are formed from ceramic matrix composite plates. The base and walls can have interconnection structures that allow for assembly. The base and walls can be coated or otherwise wrapped for connection. Locking mechanisms, such as self locking lugs, can be used for assembly.

### FIELD OF THE INVENTION

Aspects of the invention relate in general to turbine engines and, more particularly, to ceramic matrix composite components of a turbine engine.

### BACKGROUND OF THE INVENTION

FIG. 1 shows an example of one known turbine engine 10 having a compressor section 12, a combustor section 14 and a turbine section 16. In the turbine section 16, there are alternating rows of stationary airfoils 18 (commonly referred to as vanes) and rotating airfoils 20 (commonly referred to as blades). Each row of blades 20 is formed by a plurality of airfoils 20 attached to a disc 22 provided on a rotor 24. The blades 20 can extend radially outward from the discs 22 and terminate in a region known as the blade tip 26. Each row of vanes 18 is formed by attaching a plurality of vanes 18 to a vane carrier 28. The vanes 18 can extend radially inward from the inner peripheral surface 30 of the vane carrier 28. The vane carrier 28 is attached to an outer casing 32, which encloses the turbine section 16 of the engine 10.

Between the rows of vanes 18, a ring seal 34 can be attached to the inner peripheral surface 30 of the vane carrier 28. The ring seal 34 is a stationary component that acts as a hot gas path guide between the rows of vanes 18 at the locations of the rotating blades 20. The ring seal 34 is commonly formed by a plurality of metal ring segments. The ring segments can be attached either directly to the vane carrier 28 or indirectly such as by attaching to metal isolation rings (not shown) that attach to the vane carrier 28. Each ring seal 34 can substantially surround a row of blades 20 such that the tips 26 of the rotating blades 20 are in close proximity to the ring seal 34.

During engine operation, high temperature, high velocity gases flow through the rows of vanes 18 and blades 20 in the turbine section 16. The ring seals 34 are exposed to these gases as well. Some metal ring seals 34 must be cooled in order to withstand the high temperature. In many engine designs, demands to improve engine performance have been met in part by increasing engine firing temperatures. Consequently, the ring seals 34 require even greater cooling to keep the temperature of the ring seals 34 within the critical metal temperature limit. In the past, the ring seals 34 have been coated with thermal barrier coatings to minimize the amount of cooling required. However, even with a thermal barrier coating, the ring seal 34 must still be actively cooled to prevent the ring seal 34 from overheating and burning up. Such active cooling systems are usually complicated and costly. Further, the use of greater amounts of air to cool the ring seals 34 detracts from the use of air for other purposes in the engine.

As an alternative, the ring seals 34 could be made of ceramic matrix composites (CMC), which have higher temperature capabilities than metal alloys. By utilizing such materials, cooling air can be reduced, which has a direct impact on engine performance, emissions control and operating economics. However, there are a number of natural limitations and manufacturing constraints associated with CMC materials. For instance, laminated CMC materials (oxide and non-oxide based) can have anisotropic strength properties. The interlaminar tensile strength (the “through thickness” tensile strength) of the CMC can be substantially less than the in-plane strength. In addition, anisotropic shrinkage of the matrix and the fibers can result in de-lamination defects, particularly in small radius corners and tightly-curved sections, which can further reduce the interlaminar tensile strength of the material.

As shown in FIG. 2, conventional lamination processes typically result in voids at critical fillet radii in the corners of CMC box-type structures. These voids result in reduced strength and load carrying capabilities of the CMC box-type structures.

Ceramic matrix composite ring segments would typically be attached to the metal backing hardware away from the gas path where temperatures are more favorable for metals. However, as a result of such an arrangement, some of the CMC features are situated out of plane; that is, the fibers of the CMC material are not parallel to the surface of the component exposed to the hot gas path. Such out of plane features include, but are not limited to, flanges, hooks, T-joints, etc. During engine operation, differential pressure loads and other mechanical loads must be reacted by these out-of-plane features with the load path through a transition region between the features and the hot gas path surface. For instance, some ring seal segments are cooled by supplying a pressurized coolant to the backside (or “cold” side) of the ring seal segment. The coolant is at a greater pressure than the hot gases flowing through the turbine section to prevent the hot gas from being ingested in this area. As a result, the ring seal segment is subjected to pressure loading, which must be transmitted to the attachment points of the CMC ring seal segment. However, in order to do so, the pressure loading must be transmitted to the attachment points on the out of plane CMC features through a transition region (such as a fillet or other transition region) where the material is weakest. Such areas tend to be design-limiting features of these components.

Thus, there is a need for a CMC component construction, such as, for example, a ring seal segment, that can minimize the limiting aspects of CMC material properties and manufacturing constraints, and improve the mechanical and/or thermal loading capability.

### SUMMARY OF THE INVENTION

A ceramic matrix composite gas turbine component is provided that is made from independently formed substantially flat plates and assembled with interlocking structures, such as tabs and slots. The tab/slot connections can be locked by locking mechanisms such as locking pins, lugs, bayonet connections and the like. An overwrap of ceramic matrix composite can be applied for fixing the plates to one another.

The method of manufacturing described herein in the exemplary embodiments, has the advantage of simplifying manufacture, minimizing tooling costs, reducing or eliminating problematic areas for CMC laminate processing such as along small radius corners and tightly-curved sections, and reducing critical interlaminar stresses.

In one aspect, a turbine engine component is provided comprising a body having a base and a plurality of walls. Each of the base and the walls are ceramic matrix composite plates that are independently formed. The base and the plurality of walls have interconnection structures. The body is assembled by way of the interconnection structures to define a volume therein. The assembly of the base to the plurality of walls can include a base being connected to a unitary sidewall structure, such as a plurality of sidewalls that are integrally formed.

In another aspect, a turbine engine component is provided comprising a body formed by a process of independently manufacturing a plurality of plates. Each of the plurality of plates are ceramic matrix composites. The plurality of plates have interconnection structures and are assembled by the interconnection structures to define a volume therein. At least one of a coating or a wrap is disposed about at least a portion of the body to fix the plurality of plates.

In another aspect, a method of manufacturing a ceramic matrix composite gas turbine component is provided comprising: independently forming a plurality of plates from ceramic matrix composites; assembling the plurality of plates to define a volume therein; and applying a wrap to an outer surface of the plurality of plates to fix the plurality of plates to each other.

The body can define an open-ended structure. The interconnection structure can be projections that mate with corresponding recesses. The recesses can extend completely through each of the plurality of walls and the projections may extend through the recesses beyond the plurality of walls. The component can further include locking mechanisms that lock the projections in the recesses.

The locking mechanisms can be pins that are positioned through holes in the projections. The projections may have self-locking mechanisms formed thereon. The wrap can be disposed about at least a portion of the body to fix the base to the plurality of walls. The recesses can extend completely through each of the plurality of walls, with at least two of the projections extending through the recesses beyond the plurality of walls and the wrap being between the at least two projections. A coating may be applied over at least a portion of an outer surface of the body to fix the base to the plurality of walls. The component can be a ring seal segment or a combustor heat shield.

The method can include forming each of the plurality of plates with at least one interconnection structure that connects to at least one interconnection structure of another of the plurality of plates. The method can include forming locking mechanisms made from ceramic matrix composites that lock each of the at least one interconnection structures.

### BRIEF DESCRIPTION OF THE DRAWINGS

FIG. 1 is a cross-sectional view of the turbine section of a contemporary turbine engine.

FIG. 2 is a plan view of a corner portion of a contemporary CMC box-type ring seal segment.

FIG. 3 is an exploded view of a CMC box-type engine turbine component according to an exemplary embodiment of the invention.

FIG. 4 is a side view of the CMC box-type engine turbine component of FIG. 3 as assembled.

FIG. 5 is a bottom view of the CMC box-type engine turbine component of FIG. 3.

FIG. 6 is an enlarged exploded plan view of the locking mechanism for the CMC box-type engine turbine component of FIG. 3.

FIG. 7 is a bottom view of the CMC box-type engine turbine component of FIG. 5 with a wrapping or coating thereon.

FIG. 8 is an enlarged plan view of another locking mechanism that can be used with the CMC box-type engine turbine component of FIG. 3.

FIG. 9 is a perspective view of a portion of a CMC box-type engine turbine component according to another exemplary embodiment of the invention.

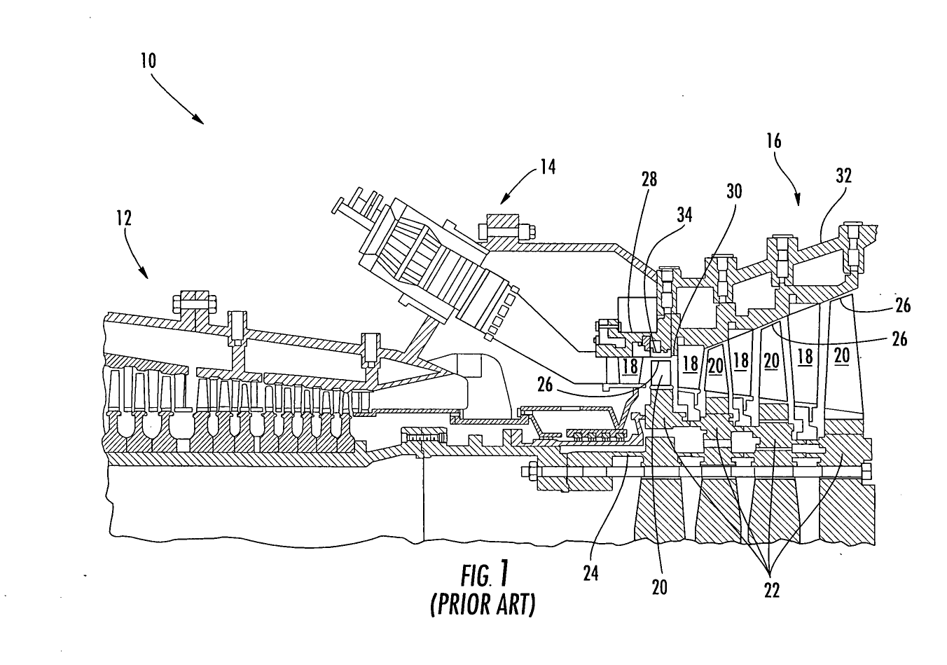

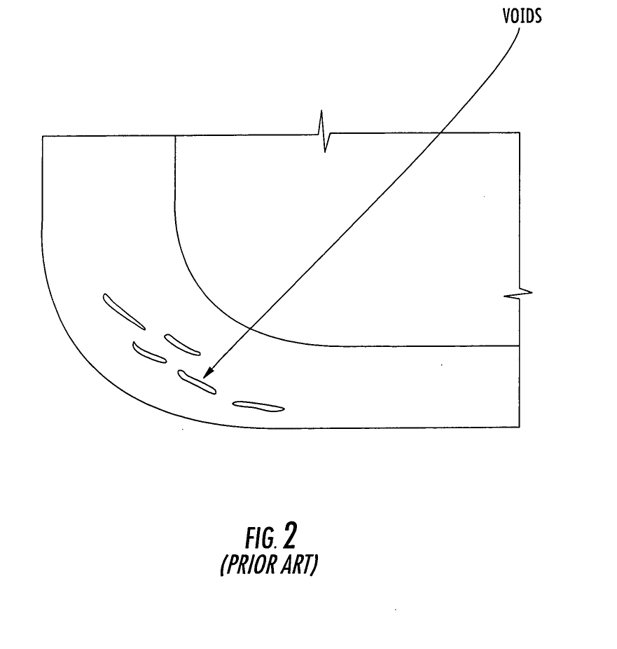

### DETAILED DESCRIPTION OF EMBODIMENTS OF THE INVENTION

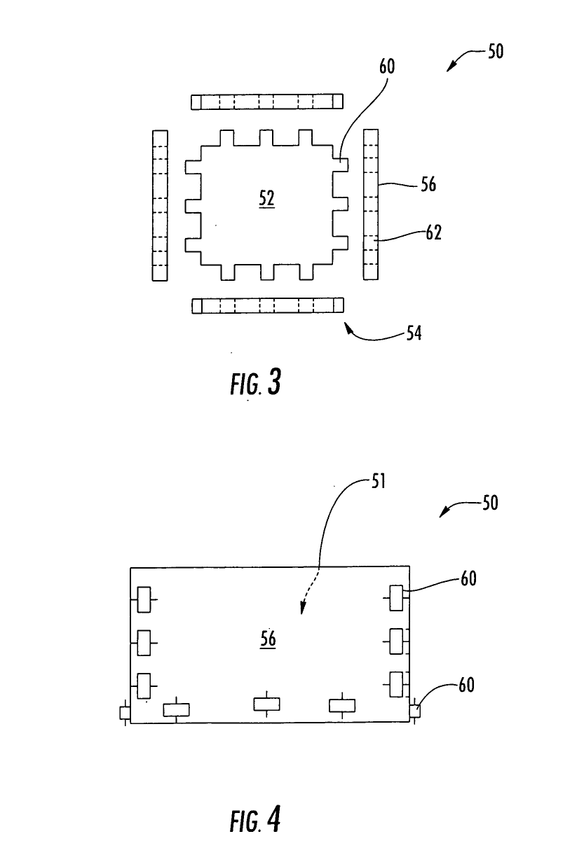

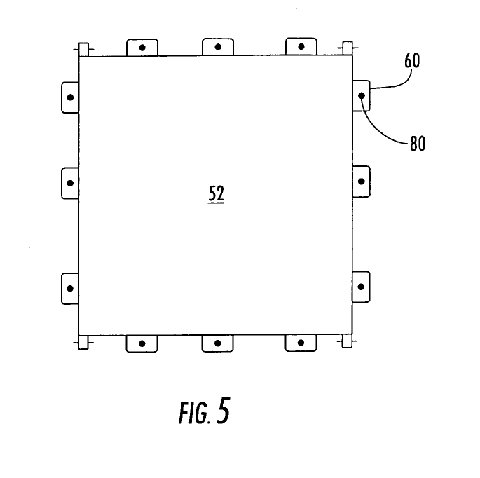

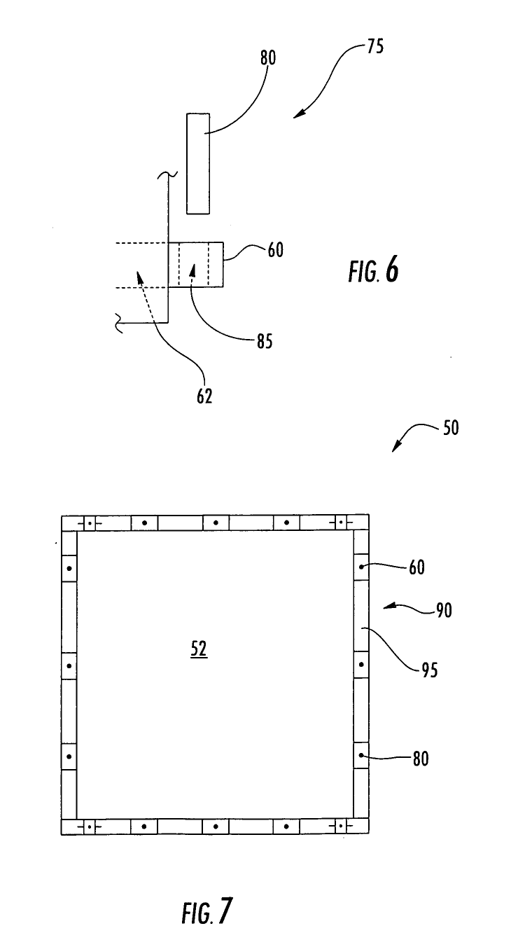

Embodiments of the invention are directed to a ceramic matrix composite (CMC) turbine engine component. Aspects of the invention will be explained in connection with a ring seal segment, but the detailed description is intended only as exemplary. Embodiments of the invention are shown in FIGS. 3-9, but the present invention is not limited to the illustrated structure or application.

Referring to FIGS. 3 through 6, a ring seal segment is shown and generally represented by reference numeral 50. Ring seal segment 50 has a base 52 and a frame 54 that is made of a plurality of walls 56. Preferably, frame 54 has four walls 56 but other shapes of the frame are contemplated by the present disclosure which would require other numbers of walls. The exemplary embodiment describes by way of example a box-type or open-ended gas turbine component as a ring seal segment 50 for the turbine section of the gas turbine. However, it should be understood that the present disclosure contemplates the use of the gas turbine component in other sections of the turbine engine, such as, for example, a combustor heat shield. The base 52 and frame 54 define a space or volume 51 which can be utilized for cooling of the ring seal segment 50. Preferably, the ring seal segment 50 defines an open-ended structure.

The ring seal segment 50 according to the exemplary embodiment described herein is to be contrasted with a ring seal segment construction that is a unitary construction. Such unitary construction results from the base portion and the frame portion being a single piece. The unitary construction of a ring seal segment can result in de-lamination defects that weaken the overall structure of the box-type component.

Each of the base 52 and the walls 56 are independently formed CMC laminate plates. The CMC plates can be an oxide based CMC. For example, the plates can be made of an oxide-oxide CMC, such as AN-720, which is available from COI Ceramics, Inc., San Diego, Calif. The plates can also be of a hybrid oxide CMC material, an example of which is disclosed in U.S. Pat. No. 6,733,907. The particular material chosen for the CMC plates can vary depending upon the particular environment for the gas turbine component.

The plates forming the base 52 and walls 56 can be formed by any suitable fabrication technique, such as winding, weaving, and fabric or unidirectional tape lay-ups. In one embodiment, ceramic fabric can be preimpregnated with matrix slurry and can be formed into or onto a mold. Each fabric ply can be cut with a unique pattern such that during lay-up, any fabric splices are not aligned between adjacent plies or occur within a minimum specified distance from splices in other superimposed plies.

The plates forming the base 52 and the walls 56 are preferably substantially flat to reduce or eliminate any de-lamination defects. However, the present disclosure contemplates use of plates that have some degree of curvature whether in thickness or in shape, such as, for example, curvature of the base 52 to provide for a ring seal when the segments 50 are assembled to the gas turbine. Additionally, the particular dimensions of the plates, including wall thickness and curvature, can be chosen based upon the particular component being fabricated, and non-uniform dimensions over a given surface are also contemplated by the present disclosure.

Each of the base 52 and the walls 56 have interconnecting structures that facilitate assembly of the ring seal segment 50 and allow for fixing of the entire structure into a stable structure. Base 52 and walls 56 can have corresponding projections or tabs 60 that mate with recesses or slots 62. In the exemplary embodiment of FIGS. 3 through 5, tabs 60 are generally rectangular structures and recesses 62 are openings formed completely through walls 56. Tabs 60 protrude through the opposing side of the walls 56 to the outside of the ring seal segment 50. However, the present disclosure contemplates the use of various sizes and shapes for the tabs 50 to facilitate assembly and strengthen the ring seal segment 50, such as, for example, tapered ends of the tabs for ease of insertion. The particular number of interconnecting structures that are used for assembly of the base 52 with the walls 56 can be chosen to facilitate assembly and strengthen the ring seal segment 50.

The tabs 50 can also be of a length so as to rest flush against the opposing side of the walls 56 or be recessed therein. Similarly, while recesses 62 are described as openings completely through the walls 56, the recesses can also be only partially through the walls such as grooves or channels formed along the inner surface of the walls. The ring seal segment 50 can also use combinations of these features such as some recesses completely through the walls 56 and some recesses that are only channels in the walls. The tabs 60 and recesses 62 can be at various angles with respect to the base 52 and walls 56 where such angles facilitate assembly, strengthen the ring seal segment 50 or provide other advantages.

The particular configuration of tabs 60 with respect to the base 52 and walls 56 can be arranged to strengthen the ring seal segment 50, to facilitate assembly, and to address other factors that are deemed significant such as sealing or gas flow path surfaces. For example, as shown in FIG. 3, base 52 has tabs 60 extending into all four walls 56 to enhance pressure load capability for the ring seal segment 50. The fore and aft walls 56 have tabs 60 extending into the two side walls to resist bending moment. The configuration of tabs 60 and recesses 62 can be arranged according to support points, mechanical loading and thermal loading of the ring seal segment 50. Such mechanical and thermal loading of the ring seal segment 50 may differ based upon the particular environment of the component.

Ring seal segment 50 has locking mechanisms 75. In the exemplary embodiment, locking mechanisms 75 are locking pins 80 that slide into locking openings 85 formed through the tabs 60. Preferably, the openings 85 are formed completely through the tabs 60 so that pins 80 abut against the walls 56 both above and below the tabs. The pins 80 can also be spaced from the walls 56 and filler material, such as, for example, a coating can be used in the space formed between the wall and pin. The coating can lock or fix the pins 80 with respect to the walls 56. The pins 80 can be made from CMC or other material suitable for the particular environment within the gas turbine. The pins 80 can be of various shapes including cylindrical and flat to facilitate assembly. The pins 80 can be wedge shaped to provide for pre-loading.

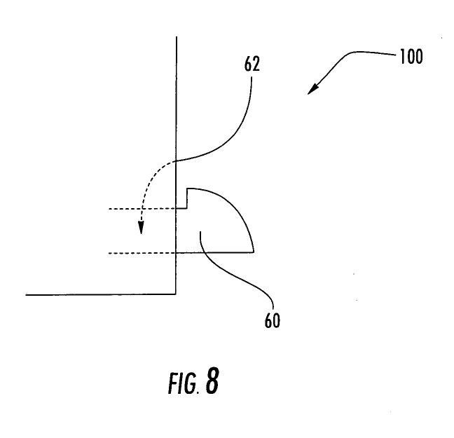

Referring to FIG. 7, ring seal segment 50 is shown having a wrap or overwrap 90 around the periphery of the segment. The particular position of the wrap 90 can be chosen to strengthen the ring seal segment 50. For example, the wrap 90 can be positioned to circumscribe the entire segment 50, can be positioned to circumscribe only the walls 56 or can be positioned locally such as along only portions of one or more of the walls. The wrap 90 is preferably a winding made from CMC, such as, for example, fabric or filament. However, the present disclosure contemplates the use of other materials for wrap 90. Wrap 90 prevents separation of the individual plates of the ring seal segment 50, e.g., the base 52 and the walls 56, and also adds to the load carrying capability of the structure. The present disclosure also contemplates the use of braded strips, tape or any combination of materials as the wrap 90 for assembling and fixing the independently formed base 52 and walls 56. The corners or edges of the segment 50 can be chamfered to facilitate application of the wrap 90.

Tabs 60 can be used to facilitate application of the wrap 90 about the ring seal segment 50. The tabs 60 can be used to wind the wrap 90 therabout. The wrap 90 can provide a substantially flat face for the ring seal segment 50 along the outer surface of the walls 56 by filling in the space 95 between the tabs 60. Such an arrangement strengthens the ring seal segment 50 while also providing a uniform gas turbine component that may be important for sealing and assembly with other components within the gas turbine.

The ring seal segment 50 can also use a coating or the like alone or in combination with the wrap 90. The coating can be applied to one or more surfaces of the segment 50, such as the outer or inner surface of walls 56, which fill in the gaps between the tabs 60 and which can be a glue or adhesive to provide bonding or binding between the plurality of plates that form one or more of the base 52 and the walls 56. The particular position of the coating can be chosen to provide strength to the structure and can include a portion of, or all of, an inner surface, an outer surface and both surfaces. The present disclosure also contemplates the use of a combination of structures, materials and methodologies for the coating or the wrap 90, as well as varying depths and positioning of the coating or wrap with respect to the ring seal segment 50.

Because the ring seal segment 50 is exposed to the hot combustion gases during engine operation, at least a portion of the radially inner surface of the ring seal segment 50 can be coated with a thermal insulating material. The thermal insulating material can be, for example, a friable graded insulation (FGI). Various examples of FGI are disclosed in U.S. Pat. Nos. 6,676,783; 6,670,046; 6,641,907; 6,287,511; 6,235,370; and 6,013,592. A layer of adhesive or other bond-enhancing material (not shown) can be used between the CMC ring seal segment 50 and the thermal insulating material to facilitate attachment.

The exemplary embodiments of FIGS. 3 through 7 use a combination of locking mechanisms 75 and wrap 90 to assemble and fix the base 52 with the walls 56. However, the present disclosure contemplates using just locking mechanisms 75 or just wrap 90 for the assembly and fixing of the base 52 with the walls 56. The particular order of assembly between the base 52 and walls 56 can be chosen to facilitate assembly and can depend on the particular configuration of the interconnection structures, e.g., tabs 60 and recesses 62. To further facilitate assembly, the interconnection structures can be provided with friction fits so that the ring seal segment 50 can be more easily manipulated during application of the wrap 90. Other structures, materials and methodologies can also be used to facilitate assembly of the ring seal segment 50, such as temporary connection mechanisms, adhesives and the like, to hold the base 52 and walls 56 together while the wrap 90 is being applied.

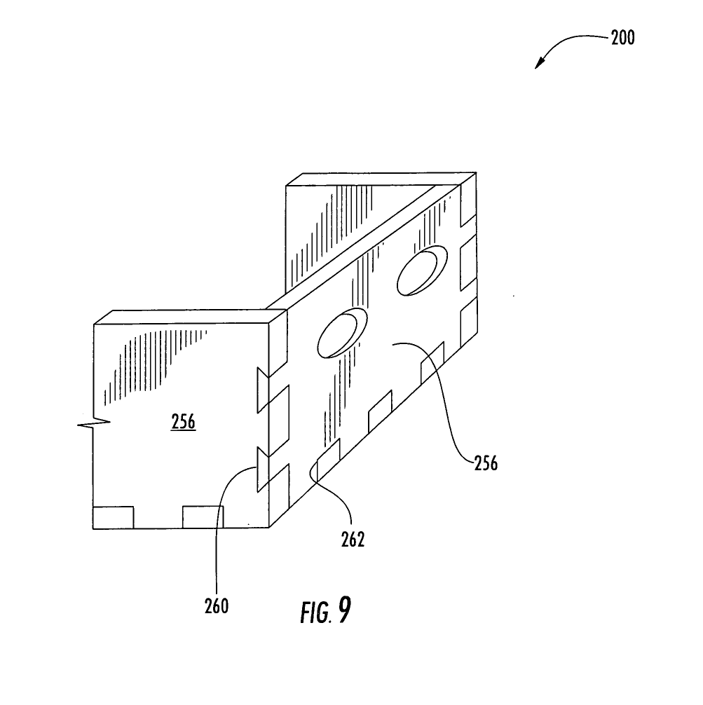

Referring to FIG. 8, another locking mechanism that can be used with ring seal segment 50 is shown and generally referred to by reference numeral 100. Locking mechanism 100 is a lug or bayonet-type structure that is formed on tab 60. The lug 100 mates with opening 62 and is a self-locking mechanism. The locking mechanism can be orientated after insertion through opening 62 to provide for locking such as by rotation or by loading of the structure. Tab 60 can also have an area of reduced thickness to allow for some bending of the tab and insertion of the lug 100 into and through opening 62. The present disclosure contemplates the use of other self-locking mechanisms to facilitate the assembly and fixing of the base 52 with the walls 56.

Referring to FIG. 9, another exemplary embodiment of a box-type gas turbine component is shown and generally referred to by reference numeral 200. Ring seal segment 200 has a base (not shown) and a plurality of walls 256. The exemplary embodiment describes by way of example a box-type gas turbine component as a ring seal segment 200 for the turbine section of the gas turbine. However, it should be understood that the present disclosure contemplates the use of the gas turbine component in other sections of the turbine engine, such as, for example, a combustor heat shield.

The ring seal segment 200 according to the exemplary embodiment described herein is to be contrasted with a ring seal segment construction that is a unitary construction. Such unitary construction results from the base portion and the frame portion being a single piece. The unitary construction of a ring seal segment can result in de-lamination defects that weaken the overall structure of the box-type component.

Each of the base and the walls 256 are independently formed CMC laminate plates. The plates forming the base and the walls 256 are preferably substantially flat to reduce or eliminate any de-lamination defects. However, the present disclosure contemplates use of plates that have some degree of curvature whether in thickness or shape, such as, for example, curvature of the base to provide for a ring seal when the segments 200 are assembled to the gas turbine.

Each of the base and the walls 256 have interconnecting structures that facilitate assembly of the ring seal segment and allow for fixing of the entire structure into a stable structure. The base and walls 256 can have corresponding projections or tabs 260 that mate with recesses 262. In the exemplary embodiment of FIG. 9, tabs 260 are a combination of generally rectangular structures and dove-tail structures, while recesses 262 are openings formed completely through walls 256 and have either rectangular or dove-tail shapes. Tabs 260 rest flush with the opposing side of the walls 256. Tabs 260 and recesses 262 are formed along an outer extent of the base and walls 260, as opposed to the tabs and openings of the ring segment 50 of FIGS. 3 through 7 which are preferably formed offset from the outer extent. However, the interconnection structures of the exemplary embodiments can also be formed along the outer extent, offset or any combination thereof. It should be further understood that the present disclosure contemplates using other types of joints between the tabs 60 or 260 and the recesses 260 or 262, including, but not limited to, butt joints, cross lapped joints, dado joints, French dovetail joints, multi-dovetail joints, doweled joints, lap butt joints, miter joints, mortise and tenon joints, rabbeted joints, scarf joints, splined joints, tongue and groove joints, and the like.

The particular configuration of tabs 260 with respect to the base and walls 256 can be arranged to strengthen the ring seal segment 200, to facilitate assembly, and to address other factors that are deemed significant. For example, the base has tabs 260 extending into all four walls 256 to enhance pressure load capability, while the walls 256 have dovetail tabs that facilitate assembly. A wrap, winding or coating can be used to further fix the separate plates of the ring seal segment 200.

The ring seal segments 50 or 200 or other CMC plate-like gas turbine components according to aspects of the invention can be installed in the gas turbine in any suitable way. For instance, the ring seal segments 50 or 200 can be operatively connected to one or more stationary support structures in the turbine section of the engine including, for example, the turbine casing, a vane carrier, forward and an aft isolation rings that extend radially inward from the vane carrier, an adapter or other connecting structure. The ring seal segments 50 or 200 can be suspended between the isolation rings. A space can be defined between the ring seal segments 50 or 200 and an inner peripheral surface of the vane carrier.

The ring seal segments 50 or 200 can be operatively connected to the stationary support structure in any of a number of ways. Two of the walls 56 or 256 can be operatively connected to the stationary support structure. In one embodiment, one or more fasteners can be used to operatively connect the ring seal segments 50 or 200 to the stationary support structure. For example, the ring seal segments 50 or 200 can be operatively connected to the stationary support structure using pins or other fastening devices.

The ring seal segments 50 or 200 can be adapted to facilitate operative connection to the stationary support structure. In one embodiment, the forward and aft side walls 56 or 256 can include one or more passages to receive the pins so as to operatively connect the ring seal segments 50 or 200 and the isolation rings. Such passages can be formed during the lamination of the plate-like structures and can be formed after the lamination process such as through water jet or laser cutting. However, the present disclosure contemplates the passages being formed by any suitable process. The passages can be sized and arranged to correspond to receive the fastening devices or pins. The passages can be oversized or slotted to allow for differential thermal expansion between the ring seal segments 50 or 200, the isolation rings, and the pins.

A first plurality of pins can operatively connect the forward isolation ring to the forward side walls 56 or 256 of the ring seal segments 50 or 200, and a second plurality of pins can operatively connect the aft isolation ring to the aft side walls 56 or 256 of the ring seal segments 50 or 200. The pins can be made of any suitable material, such as metal. The pins can have any cross-sectional shape, such as circular, polygonal or rectangular. The first and second plurality of pins may or may not be substantially identical to each other. At least some of the pins can be removable. It will be understood that such an arrangement is provided to facilitate discussion, and aspects of the invention are not limited to such an arrangement. Any quantity of pins can be used to operatively connect the forward side walls 56 or 256 and the forward isolation ring. The number and arrangement of the pins can be optimized for the load conditions and specific geometric allowances. In one embodiment, the quantity and/or the arrangement of the first plurality of pins can be substantially identical to the quantity and the arrangement of the second plurality pins. However, the quantity and/or arrangement of the first plurality of pins can be different from the quantity and arrangement of second plurality of pins. At least some of the pins can be threaded.

Additional ring seal segments 50 or 200 can be attached to the stationary support structure in a similar manner to that described above. The plurality of the ring seal segments 50 or 200 can be installed so that each circumferential side of one ring seal segment 50 or 200 substantially abuts one of the circumferential sides of a neighboring ring seal segments 50 or 200 so as to collectively form an annular ring seal. The ring seal segments 50 or 200 can substantially surround a row of blades such that the tips of the rotating blades are in close proximity to the ring seal.

The base and walls of ring seal segments 50 or 200 that are independently formed and then assembled according to the exemplary embodiments described above, can be readily manufactured without de-lamination defects due to their plate-like shape. The process can be automated and precise shapes can be formed using high-volume production. Superior manufacturing techniques, such as, for example, water jet cutting and laser cutting can be used to make the process even more efficient. The assembly of plate-like CMC components via interconnection structures, locking mechanisms and/or wrapping, winding or coating provides high quality, low-cost manufacturing that can render the use of CMC production cost-effective. The production of the above-described exemplary embodiments also reduces tooling expenses for the lamination of the plate-like pieces and allows for non-destructive evaluation techniques to be readily applied to control of the process.

It should be further understood that the CMC gas turbine components described by way of the exemplary embodiments can have other features known to be used in gas turbines. For example, other structures may be defined by, or connected to, the ring seal segments 50 and 200 such as to facilitate connection of the ring seal segments to the gas turbine, to provide for cooling via cooling channels defined in the segments, to provide for sealing via sealing slots defined in the segments and/or to provide other functions for the ring seal segments.

The box-type structures of the exemplary embodiments provide for good resistance to both thermal and mechanical loads that are frequently seen in gas turbines. The ring seal segments 50 and 200 can be subjected to temperatures of 1200° C. to more than 1600° C. and/or subjected to pressure differentials of 12 to 60 psi. Under these conditions, the ring seal segments 50 and 200 can be subjected to cooling and can still resist the thermal and mechanical loads due to the structure, manufacturing and assembly processes described above.

It will be understood that the invention is not limited to the specific details described herein, which are given by way of example only, and that various modifications and alterations are possible within the scope of the invention as defined in the following claims.

We claim:

1. A turbine engine component comprising:
a body having a base and a plurality of walls, each of the base and the plurality of walls being ceramic matrix composite plates that are independently formed, the base and the plurality of walls having interconnection structures, the body being assembled by the interconnection structures to define a volume therein.

2. The component of claim 1, wherein the body defines an open-ended structure.

3. The component of claim 1, wherein the interconnection structures are projections that mate with corresponding recesses.

4. The component of claim 3, wherein the recesses extend completely through each of the plurality of walls and wherein the projections extend through the recesses beyond the plurality of walls.

5. The component of claim 4, further comprising locking mechanisms that lock the projections in the recesses.

6. The component of claim 5, wherein the locking mechanisms are pins that are positioned through holes in the projections.

7. The component of claim 4, wherein the projections have self-locking mechanisms formed thereon.

8. The component of claim 1, wherein a wrap is applied on at least a portion of the body to fix the plurality of walls.

9. The component of claim 3, wherein a wrap is applied on at least a portion of the body to fix the base to the plurality of walls, wherein the recesses are completely through each of the plurality of walls, wherein at least two of the projections extend through the recesses beyond the plurality of walls and wherein the wrap is disposed between the at least two projections.

10. The component of claim 3, wherein the recesses extend completely through each of the plurality of walls, wherein the projections extend through the recesses beyond the plurality of walls, wherein a coating is applied over at least a portion of a surface of the body and wherein the coating fills at least one gap in the body.

11. A turbine engine component comprising:
a body formed by a process of independently manufacturing a plurality of plates, each of the plurality of plates being ceramic matrix composites, the plurality of plates having interconnection structures and being assembled by the interconnection structures to define a volume therein, wherein at least one of a coating or a wrap is applied on at least a portion of the body to fix the plurality of plates.

12. The component of claim 11, wherein the body defines an open-ended structure.

13. The component of claim 11, wherein the interconnection structures are projections that mate with corresponding recesses.

14. The component of claim 13, wherein the recesses extend completely through each of the plurality of plates.

15. The component of claim 14, further comprising locking mechanisms that lock the projections in the corresponding recesses.

16. The component of claim 13, wherein the projections have self-locking mechanisms formed thereon.

17. The component of claim 11, wherein the component is a ring seal segment or a combustor heat shield.

18. A method of manufacturing a ceramic matrix composite gas turbine component comprising:
independently forming a plurality of plates from ceramic matrix composites;
assembling the plurality of plates to define a volume therein; and
applying a wrap to an outer surface of the plurality of plates to fix the plurality of plates to each other.

19. The method of claim 18, further comprising forming each of the plurality of plates with at least one interconnection structure that connects to at least one interconnection structure of another of the plurality of plates.

20. The method of claim 19, further comprising forming locking mechanisms made from ceramic matrix composites that lock each of the at least one interconnection structures.
